(19) United States
(12) Patent Application Publication
(10) Pub. No.: US 2024/0267956 A1
(43) Pub. Date: Aug. 8, 2024

(54) RANDOM ACCESS METHOD, USER EQUIPMENT AND NETWORK-SIDE EQUIPMENT

(71) Applicant: DATANG MOBILE COMMUNICATIONS EQUIPMENT CO., LTD., Beijing (CN)

(72) Inventors: Liming HOU, Beijing (CN); Deshan MIAO, Beijing (CN); Shaoli KANG, Beijing (CN); Shaohui SUN, Beijing (CN)

(73) Assignee: DATANG MOBILE COMMUNICATIONS EQUIPMENT CO., LTD., Beijing (CN)

(21) Appl. No.: 18/566,616

(22) PCT Filed: Jun. 1, 2022
(86) PCT No.: PCT/CN2022/096613

§ 371 Date: Dec. 1, 2023

(30) Foreign Application Priority Data
Jun. 4, 2021 (CN) 202110624223.5

(51) Int. Cl. H04W 74/0833; H04W 64/00; H04W 72/044

(52) U.S. Cl. CPC H04W 74/0833; H04W 64/00; H04W 72/046

(57) ABSTRACT

A random access method, a user equipment and a network-side equipment are provided, related to the field of communication technology. The method includes: sending to a network-side equipment, by a user equipment, a service beam resource request message required for a random access, in a control beam of a hopping beam; receiving in the control beam, by the user equipment, resource configuration information sent by the network-side equipment; and initiating, by the user equipment, a random access process in a service beam of the hopping beam according to the resource configuration information.

### CROSS REFERENCE OF RELATED APPLICATION

The present disclosure claims a priority of Chinese patent disclosure No. 202110624223.5 filed on Jun. 4, 2021, which is incorporated herein by reference in its entirety.

### TECHNICAL FIELD

The present disclosure relates to the field of communication technology, and in particular, to a random access method, a user equipment and a network-side equipment.

### BACKGROUND

The satellite hopping beam communication system consists of a ground gateway station, a satellite (beam pointing hopping) and user equipment (UE). The ground gateway station is such as a base station (NR Node B, GNB). The use of hopping beam technology in low-orbit satellite communication systems can increase system capacity, reduce interference and improve configuration flexibility. The hopping beam hops within the coverage of the satellite cell according to a certain period. The pointing direction of each jumping beam will change. The single stay time of the beam in each spatial direction is called the dwell time; beam jumping Visiting all candidate orientations once is called a hopping cycle. Hopping beams are divided into control hopping beams (referred to as control beams) and service hopping beams (referred to as service beams) according to their functions.

In related art, when control beams and service beams are configured separately, the control beam is generally used for interactive signaling, in which processes such as uplink and downlink synchronization, random access, and resource scheduling are completed by the control beam. Due to the burst nature of control beam signaling and the polling method during the hopping process, the control beam will be in a low-load state most of the time. Therefore, when satellite power resources are extremely limited, the resource will be wasted.

### SUMMARY

The preset disclosure is to provide a random access method, user equipment and network-side equipment to solve the problem of resource waste caused by random access methods in related art.

A random access method is provided in an embodiment of the present disclosure, including:
sending to a network-side equipment, by a user equipment, a service beam resource request message required for a random access, in a control beam of a hopping beam;
receiving in the control beam, by the user equipment, resource configuration information sent by the network-side equipment; and
initiating, by the user equipment, a random access process in a service beam of the hopping beam according to the resource configuration information.

Optionally, the service beam resource request message includes: a detection sequence of the user equipment;
or
the service beam resource request message includes: a detection sequence of the user equipment and location information of the user equipment.

Optionally, the detection sequence includes one of the following:
a first preamble sequence;
a second preamble sequence with a length greater than or equal to a first value;
a third preamble sequence authorized to be scrambled and with a length greater than or equal to a first value.

Optionally, the location information includes at least one of the following:
the user equipment's longitude-latitude information and elevation information on the ground;
the user equipment's wave position information.

Optionally, the service beam resource request message implicitly indicates the location information of the user equipment;
the way in which the service beam resource request message implicitly indicates the location information of the user equipment includes one of the following:
the detection sequence corresponds to a wave position where the user equipment is located;
a set of detection sequences corresponds to the wave position where the user equipment is located;
the detection sequence and a random access channel occasion (RO) time-frequency resource correspond to a wave position where the user equipment is located.

Optionally, the location information of the user equipment includes: the wave position information of the user equipment;
prior to the sending to the network-side equipment the service beam resource request message required for the random access, the method further includes: obtaining the wave position information of the user equipment;
according to a correspondence between the wave position information and the detection sequence, determining the detection sequence corresponding to the wave position information;
where the correspondence between the wave position information and the detection sequence is sent by the network-side equipment or calculated by the user equipment.

Optionally, the obtaining the wave position information of the user equipment includes:
determining a wave position number of a wave position where the user equipment is located, based on the global navigation satellite system;
or
obtaining a wave position number of a wave position where the user equipment is located, from a downlink broadcast signal in the control beam.

Optionally, the resource configuration information includes:
a resource request response message;
service beam scheduling information.

Optionally, the service beam scheduling information includes: an access time, a frequency band configuration and a residence time of the service beam.

Optionally, when the resource request response message indicates that no service beam resource is schedulable, the method further includes:
repeatedly sending the service beam resource request message according to a predetermined period.

Optionally, the initiating the random access process in the service beam of the hopping beam according to the resource configuration information includes:
determining a random access mode of the random access process according to a configuration of the network-side equipment or by a user equipment's definition;
performing a random access process in the service beam, according to the random access method;
where when the random access mode is configured by the network-side equipment, the resource configuration information includes indication information of the random access mode.

Optionally, the performing the random access process in the service beam according to the random access method includes:
sending a first message to the network-side equipment in the service beam, where the first message includes a physical random access channel (PRACH) signal;
receiving, in the service beam, random access response (RAR) information sent by the network-side equipment;
sending a second message to the network-side equipment in the service beam, where the second message includes: a user equipment identity and a radio resource control (RRC) connection request; and
receiving, in the service beam, random access success feedback information sent by the network-side equipment.

Optionally, the performing the random access process according to the random access mode includes:
sending a third message to the network-side equipment in the service beam, where the third message includes a PRACH signal, a user equipment identity and an RRC connection request;
receiving, in the service beam, random access success feedback information sent by the network-side equipment.

Optionally, when the service beam resource request message does not include wave position information of the user equipment, the RAR information includes the wave position information of the user equipment.

A random access method is further provided in an embodiment of the present disclosure, including:
receiving, by a network-side equipment, a service beam resource request message sent by a user equipment in a control beam of a hopping beam;
determining, by the network-side equipment, resource configuration information according to the service beam resource request message and a resource utilization status; and
sending in the control beam, by the network-side equipment, the resource configuration information to the user equipment.

Optionally, the service beam resource request message includes: a detection sequence of the user equipment;
or
the service beam resource request message includes: a detection sequence of the user equipment and location information of the user equipment.

Optionally, the detection sequence includes one of the following:
a first preamble sequence;
a second preamble sequence with a length greater than or equal to a first value;
a third preamble sequence authorized to be scrambled and with a length greater than or equal to a first value.

Optionally, the location information includes at least one of the following:
the user equipment's longitude-latitude information and elevation information on the ground;
the user equipment's wave position information.

Optionally, the service beam resource request message implicitly indicates the location information of the user equipment;
the way in which the service beam resource request message implicitly indicates the location information of the user equipment includes one of the following:
the detection sequence corresponds to a wave position where the user equipment is located;
a set of detection sequences corresponds to the wave position where the user equipment is located;
the detection sequence and a random access channel occasion (RO) time-frequency resource correspond to a wave position where the user equipment is located.

Optionally, the location information of the user equipment includes: the wave position information of the user equipment;
prior to the receiving the service beam resource request message sent by the user equipment in the control beam of the hopping beam, the method further includes:
establishing a correspondence between the wave position information and the detection sequence;
sending the correspondence to the user equipment.

Optionally, the method further includes:
sending a downlink broadcast signal in the control beam, where the downlink broadcast signal includes the wave position number of the control beam.

Optionally, the resource configuration information includes:
a resource request response message;
service beam scheduling information.

Optionally, the service beam scheduling information includes: an access time, a frequency band configuration and a residence time of the service beam.

Optionally, subsequent to the sending the resource configuration information to the user equipment in the control beam, the method further includes:
performing the random access process initiated by the user equipment in the service beam of the hopping beam.

Optionally, the performing the random access process initiated by user equipment in the service beam of the hopping beam includes:
receiving a first message sent by the user equipment in the service beam, where the first message includes a physical random access channel (PRACH) signal;
according to the first message, sending random access response (RAR) information to the user equipment in the service beam;
receiving a second message sent by the user equipment in the service beam, where the second message includes: a user equipment identity and a radio resource control (RRC) connection request; and
sending random access success feedback information to the user equipment in the service beam.

Optionally, the performing the random access process initiated by user equipment in the service beam of the hopping beam includes:
receiving a third message sent by the user equipment in the service beam, where the third message includes a PRACH signal, a user equipment identity and an RRC connection request;
sending random access success feedback information to the user equipment in the service beam.

Optionally, when the service beam resource request message does not include wave position information of the user equipment, the RAR information includes the wave position information of the user equipment.

A user equipment is further provided in an embodiment of the present disclosure, including: a storage, a transceiver and a processor, where
the storage is configured to store computer programs; the transceiver is configured to send and receive data under a control of the processor and perform:
sending to a network-side equipment, a service beam resource request message required for a random access, in a control beam of a hopping beam;
receiving in the control beam, resource configuration information sent by the network-side equipment; and
the processor is configured to read the computer program in the storage to perform:
initiating a random access process in a service beam of the hopping beam according to the resource configuration information.

Optionally, the service beam resource request message includes: a detection sequence of the user equipment;
or
the service beam resource request message includes: a detection sequence of the user equipment and location information of the user equipment.

Optionally, the detection sequence includes one of the following:
a first preamble sequence;
a second preamble sequence with a length greater than or equal to a first value;
a third preamble sequence authorized to be scrambled and with a length greater than or equal to a first value.

Optionally, the location information includes at least one of the following:
the user equipment's longitude-latitude information and elevation information on the ground;
the user equipment's wave position information.

Optionally, the service beam resource request message implicitly indicates the location information of the user equipment;
the way in which the service beam resource request message implicitly indicates the location information of the user equipment includes one of the following:
the detection sequence corresponds to a wave position where the user equipment is located;
a set of detection sequences corresponds to the wave position where the user equipment is located;
the detection sequence and a random access channel occasion (RO) time-frequency resource correspond to a wave position where the user equipment is located.

Optionally, the location information of the user equipment includes: the wave position information of the user equipment;
prior to the sending to the network-side equipment the service beam resource request message required for the random access, the processor is further configured to read the computer program in the storage to perform:
obtaining the wave position information of the user equipment;
according to a correspondence between the wave position information and the detection sequence, determining the detection sequence corresponding to the wave position information;
where the correspondence between the wave position information and the detection sequence is sent by the network-side equipment or calculated by the user equipment.

Optionally, the obtaining the wave position information of the user equipment includes:
determining a wave position number of a wave position where the user equipment is located, based on the global navigation satellite system;
or
obtaining a wave position number of a wave position where the user equipment is located, from a downlink broadcast signal in the control beam.

Optionally, the resource configuration information includes:
a resource request response message;
service beam scheduling information.

Optionally, the service beam scheduling information includes: an access time, a frequency band configuration and a residence time of the service beam.

Optionally, when the resource request response message indicates that no service beam resource is schedulable, the transceiver is further configured to perform:
repeatedly sending the service beam resource request message according to a predetermined period.

Optionally, the initiating the random access process in the service beam of the hopping beam according to the resource configuration information includes:
determining a random access mode of the random access process according to a configuration of the network-side equipment or by a user equipment's definition;
performing a random access process in the service beam, according to the random access method;
where when the random access mode is configured by the network-side equipment, the resource configuration information includes indication information of the random access mode.

Optionally, the performing the random access process in the service beam according to the random access method includes:
sending a first message to the network-side equipment in the service beam, where the first message includes a physical random access channel (PRACH) signal;
receiving, in the service beam, random access response (RAR) information sent by the network-side equipment;
sending a second message to the network-side equipment in the service beam, where the second message includes: a user equipment identity and a radio resource control (RRC) connection request; and
receiving, in the service beam, random access success feedback information sent by the network-side equipment.

Optionally, the performing the random access process according to the random access mode includes:
sending a third message to the network-side equipment in the service beam, where the third message includes a PRACH signal, a user equipment identity and an RRC connection request;
receiving, in the service beam, random access success feedback information sent by the network-side equipment.

Optionally, when the service beam resource request message does not include wave position information of the user equipment, the RAR information includes the wave position information of the user equipment.

A network-side equipment is further provided in an embodiment of the present disclosure, including: a storage, a transceiver and a processor, where
the storage is configured to store computer programs; the transceiver is configured to send and receive data under a control of the processor and perform:
receiving a service beam resource request message sent by a user equipment in a control beam of a hopping beam;
the processor is configured to read the computer program in the storage to perform:
determining resource configuration information according to the service beam resource request message and a resource utilization status; and
the transceiver is further configured to perform:
sending in the control beam, the resource configuration information to the user equipment.

Optionally, the service beam resource request message includes: a detection sequence of the user equipment;
or
the service beam resource request message includes: a detection sequence of the user equipment and location information of the user equipment.

Optionally, the detection sequence includes one of the following: a first preamble sequence;
a second preamble sequence with a length greater than or equal to a first value;
a third preamble sequence authorized to be scrambled and with a length greater than or equal to a first value.

Optionally, the location information includes at least one of the following:
the user equipment's longitude-latitude information and elevation information on the ground;
the user equipment's wave position information.

Optionally, the service beam resource request message implicitly indicates the location information of the user equipment;
the way in which the service beam resource request message implicitly indicates the location information of the user equipment includes one of the following:
the detection sequence corresponds to a wave position where the user equipment is located;
a set of detection sequences corresponds to the wave position where the user equipment is located;
the detection sequence and a random access channel occasion (RO) time-frequency resource correspond to a wave position where the user equipment is located.

Optionally, the location information of the user equipment includes: the wave position information of the user equipment;
prior to the receiving the service beam resource request message sent by the user equipment in the control beam of the hopping beam, the processor is further configured to perform:
establishing a correspondence between the wave position information and the detection sequence;
the transceiver is further configured to perform:
sending the correspondence to the user equipment.

Optionally, the transceiver is further configured to:
sending a downlink broadcast signal in the control beam, where the downlink broadcast signal includes the wave position number of the control beam.

Optionally, the resource configuration information includes:
a resource request response message;
service beam scheduling information.

Optionally, the service beam scheduling information includes: an access time, a frequency band configuration and a residence time of the service beam.

Optionally, subsequent to the sending the resource configuration information to the user equipment in the control beam, the processor is further configured to perform:
performing the random access process initiated by the user equipment in the service beam of the hopping beam.

Optionally, performing the random access process initiated by user equipment in the service beam of the hopping beam includes:
receiving a first message sent by the user equipment in the service beam, where the first message includes a physical random access channel (PRACH) signal;
according to the first message, sending random access response (RAR) information to the user equipment in the service beam;
receiving a second message sent by the user equipment in the service beam, where the second message includes: a user equipment identity and a radio resource control (RRC) connection request; and
sending random access success feedback information to the user equipment in the service beam.

Optionally, the performing the random access process initiated by user equipment in the service beam of the hopping beam includes:
receiving a third message sent by the user equipment in the service beam, where the third message includes a PRACH signal, a user equipment identity and an RRC connection request;
sending random access success feedback information to the user equipment in the service beam.

Optionally, when the service beam resource request message does not include wave position information of the user equipment, the RAR information includes the wave position information of the user equipment.

A random access apparatus is further provided in an embodiment of the present disclosure, including:
a first sending unit, configured to send to a network-side equipment, a service beam resource request message required for a random access, in a control beam of a hopping beam;
a first receiving unit, configured to receive in the control beam, resource configuration information sent by the network-side equipment; and
a first random access unit, configured to initiate a random access process in a service beam of the hopping beam according to the resource configuration information.

Optionally, the service beam resource request message includes: a detection sequence of the user equipment;
or
the service beam resource request message includes: a detection sequence of the user equipment and location information of the user equipment.

Optionally, the detection sequence includes one of the following:
a first preamble sequence;
a second preamble sequence with a length greater than or equal to a first value;
a third preamble sequence authorized to be scrambled and with a length greater than or equal to a first value.

Optionally, the location information includes at least one of the following:
the user equipment's longitude-latitude information and elevation information on the ground;
the user equipment's wave position information.

Optionally, the service beam resource request message implicitly indicates the location information of the user equipment;
the way in which the service beam resource request message implicitly indicates the location information of the user equipment includes one of the following:
the detection sequence corresponds to a wave position where the user equipment is located;
a set of detection sequences corresponds to the wave position where the user equipment is located;
the detection sequence and a random access channel occasion (RO) time-frequency resource correspond to a wave position where the user equipment is located.

Optionally, the location information of the user equipment includes: the wave position information of the user equipment;
the apparatus further includes:
a first obtaining unit, configured to obtain the wave position information of the user equipment;
a second determining unit, configured to, according to a correspondence between the wave position information and the detection sequence, determine the detection sequence corresponding to the wave position information;
where the correspondence between the wave position information and the detection sequence is sent by the network-side equipment or calculated by the user equipment.

Optionally, the first obtaining unit is further configured to:
determine a wave position number of a wave position where the user equipment is located, based on the global navigation satellite system;
or
obtain a wave position number of a wave position where the user equipment is located, from a downlink broadcast signal in the control beam.

Optionally, the resource configuration information includes:
a resource request response message;
service beam scheduling information.

Optionally, the service beam scheduling information includes: an access time, a frequency band configuration and a residence time of the service beam.

Optionally, when the resource request response message indicates that no service beam resource is schedulable, the device further includes:
a third sending unit, configured to repeatedly send the service beam resource request message according to a predetermined period.

Optionally, the first random access unit includes:
a first determining sub-unit, configured to determine a random access mode of the random access process according to a configuration of the network-side equipment or by a user equipment's definition;
a first access sub-unit, configured to perform a random access process in the service beam, according to the random access method;
where when the random access mode is configured by the network-side equipment, the resource configuration information includes indication information of the random access mode.

Optionally, the first access sub-unit is further configured to:
send a first message to the network-side equipment in the service beam, where the first message includes a physical random access channel (PRACH) signal;
receive, in the service beam, random access response (RAR) information sent by the network-side equipment;
send a second message to the network-side equipment in the service beam, where the second message includes: a user equipment identity and a radio resource control (RRC) connection request; and
receive, in the service beam, random access success feedback information sent by the network-side equipment.

Optionally, the access sub-unit is further configured to:
send a third message to the network-side equipment in the service beam, where the third message includes a PRACH signal, a user equipment identity and an RRC connection request;
receive, in the service beam, random access success feedback information sent by the network-side equipment.

Optionally, when the service beam resource request message does not include wave position information of the user equipment, the RAR information includes the wave position information of the user equipment.

A random access apparatus is further provided in embodiment of the present disclosure, includes:
a second receiving unit, configured to receive a service beam resource request message sent by a user equipment in a control beam of a hopping beam;
a first determining unit, configured to determine resource configuration information according to the service beam resource request message and a resource utilization status; and
a second sending unit, configured to send in the control beam the resource configuration information to the user equipment.

Optionally, the service beam resource request message includes: a detection sequence of the user equipment;
or
the service beam resource request message includes: a detection sequence of the user equipment and location information of the user equipment.

Optionally, the detection sequence includes one of the following:
a first preamble sequence;
a second preamble sequence with a length greater than or equal to a first value;
a third preamble sequence authorized to be scrambled and with a length greater than or equal to a first value.

Optionally, the location information includes at least one of the following:
the user equipment's longitude-latitude information and elevation information on the ground;
the user equipment's wave position information.

Optionally, the service beam resource request message implicitly indicates the location information of the user equipment;
the way in which the service beam resource request message implicitly indicates the location information of the user equipment includes one of the following:
the detection sequence corresponds to a wave position where the user equipment is located;
a set of detection sequences corresponds to the wave position where the user equipment is located;
the detection sequence and a random access channel occasion (RO) time-frequency resource correspond to a wave position where the user equipment is located.

Optionally, the location information of the user equipment includes: the wave position information of the user equipment;
the apparatus further includes:
an establishing unit, configured to establish a correspondence between the wave position information and the detection sequence;
a fourth sending unit, configured to send the correspondence to the user equipment.

Optionally, the random access apparatus further includes:
a fifth sending unit, configured to send a downlink broadcast signal in the control beam, where the downlink broadcast signal includes the wave position number of the control beam.

Optionally, the resource configuration information includes:
a resource request response message;
Optionally, the service beam scheduling information includes: an access time, a frequency band configuration and a residence time of the service beam.

Optionally, the random access apparatus further includes:
a second random access unit, configured to perform the random access process initiated by the user equipment in the service beam of the hopping beam.

Optionally, the second random access unit is further configured to:
receive a first message sent by the user equipment in the service beam, where the first message includes a physical random access channel (PRACH) signal;
according to the first message, send random access response (RAR) information to the user equipment in the service beam;
receive a second message sent by the user equipment in the service beam, where the second message includes: a user equipment identity and a radio resource control (RRC) connection request; and
send random access success feedback information to the user equipment in the service beam.

Optionally, the second random access unit is further configured to:
receive a third message sent by the user equipment in the service beam, where the third message includes a PRACH signal, a user equipment identity and an RRC connection request;
send random access success feedback information to the user equipment in the service beam.

Optionally, when the service beam resource request message does not include wave position information of the user equipment, the RAR information includes the wave position information of the user equipment.

A processor-readable storage medium is further provided in an embodiment of the present disclosure, storing a computer program, and where the computer program is executed by a processor to perform the random access method hereinabove.

The beneficial effects of the above technical solutions of the present disclosure are:
according to the embodiment of the present disclosure, the user equipment applies for the service beam resources required for random access in the control beam of the hopping beam, and obtains the resource configuration information of the service beam sent by the network-side equipment in the control beam. According to the resource configuration information, the user equipment initiates random access in the service beam, thereby simplifying the control beam design, reducing the power, bandwidth and other configurations of the control beam, increasing the power configuration of the service beam, and improving the resource utilization of the communication system.

### BRIEF DESCRIPTION OF THE DRAWINGS

FIG. 1 shows a schematic view of the NR beam scanning principle;

FIG. 2 is a schematic view of the low-orbit satellite hopping beam communication system;

FIG. 3 is a first schematic flowchart of a random access method according to an embodiment of the present disclosure;

FIG. 4 is a second schematic flowchart of a random access method according to an embodiment of the present disclosure;

FIG. 5 is a third schematic flowchart of a random access method according to an embodiment of the present disclosure;

FIG. 6 is a fourth schematic flowchart of a random access method according to an embodiment of the present disclosure;

FIG. 7 is a fifth schematic flowchart of a random access method according to an embodiment of the present disclosure;

FIG. 8 is a first schematic view of a random access equipment according to an embodiment of the present disclosure;

FIG. 9 is a second schematic view of a random access equipment according to an embodiment of the present disclosure;

FIG. 10 is a schematic view of a user equipment according to an embodiment of the present disclosure; and

FIG. 11 is a schematic view of a network-side equipment according to an embodiment of the present disclosure.

### DETAILED DESCRIPTION

In order to make the technical problems, technical solutions and advantages to be solved by the present disclosure clearer, a detailed description will be given below with reference to the accompanying drawings and specific embodiments. In the following description, specific details, such as specific configurations and components, are provided solely to assist in a comprehensive understanding of embodiments of the present disclosure. Accordingly, it will be apparent to those skilled in the art that various changes and modifications can be made to the embodiments described herein without departing from the scope and spirit of the disclosure. Additionally, descriptions of known functions and construction are omitted for clarity and conciseness.

It will be understood that reference throughout this specification to “one embodiment” or “an embodiment” means that a particular feature, structure, or characteristic associated with the embodiment is included in at least one embodiment of the present disclosure. Thus, the appearances of “in one embodiment” or “in an embodiment” in various places throughout this specification are not necessarily referring to the same embodiment. Furthermore, the particular features, structures or characteristics may be combined in any suitable manner in one or more embodiments.

In various embodiments of the present disclosure, it should be understood that the size of the sequence numbers of the following processes does not mean the order of execution. The execution order of each process should be determined by its functions and internal logic, and should not be implemented in the present disclosure. The implementation of the examples does not constitute any limitations.

In the embodiment of this disclosure, the term “and/or” describes the association relationship of associated objects, indicating that there can be three relationships, for example, A and/or B, which can mean: A exists alone, A and B exist simultaneously, and B exists alone. The character “/” generally indicates that the related objects are an “or” relationship.

In the embodiment of this disclosure, the term “plurality” refers to two or more than two, and other quantifiers are similar to it.

The technical solutions in the embodiments of the present disclosure will be clearly and completely described below with reference to the accompanying drawings in the embodiments of the present disclosure. Obviously, the described embodiments are only some of the embodiments of the present disclosure, not all of them. Based on the embodiments in this disclosure, all other embodiments obtained by those of ordinary skill in the art without creative efforts fall within the scope of protection of this disclosure.

When describing the embodiments of the present disclosure, some concepts used in the following description will first be explained.

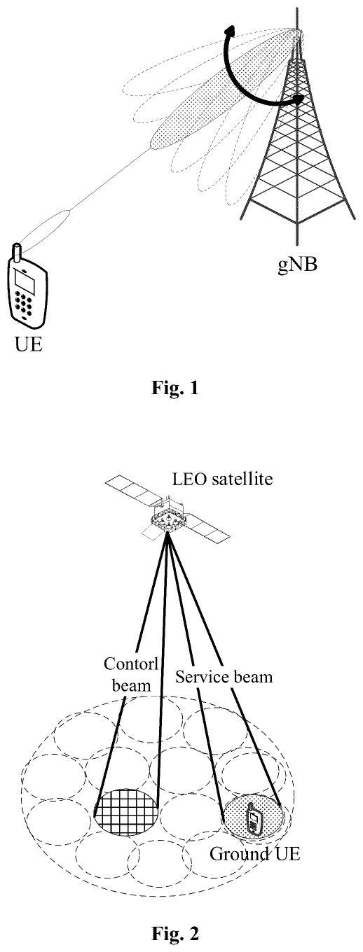

Terrestrial 5G beam scanning system: The 5G NR cellular mobile communication system adopts beam scanning technology. Through beam management, network resources can be more effectively utilized to provide services for UEs in the community. The principle of NR beam scanning is shown in FIG. 1. In the current 5G NR standard, the beam management scheme does not distinguish between control beams and service beams. Both types of data are transmitted through the same beam. It has no impact on the random access process of user equipment.

Satellite hopping beam communication system: Taking Low Earth Orbit (LEO) as an example, the low earth orbit satellite hopping beam communication system is shown in FIG. 2. The hopping beam includes control beams and service beams. The control beam is generally used in the polling mode hopping, the service beam hops according to business requirements or Quality of Service (QOS) guarantee scheme.

It can be seen from FIGS. 1 and 2 that service beams and control beams have different functions, different transmission contents, and different hopping periods. The control beam mainly transmits control signaling; the service beam mainly transmits user data.

Specifically, embodiments of the present disclosure provide a random access method, a user equipment, a network-side equipment to solve the problem of resource waste caused by random access methods in related art.

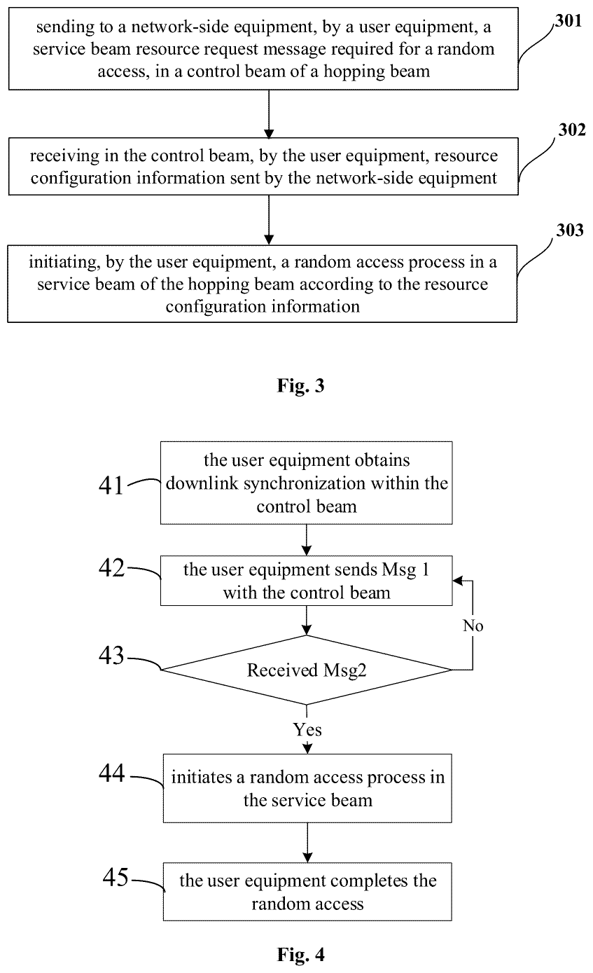

As shown in FIG. 3, embodiments of the present disclosure provide a random access method, which is applied to user equipment and specifically includes the following steps:
Step 301: sending to a network-side equipment, by a user equipment, a service beam resource request message required for a random access, in a control beam of a hopping beam.

The user equipment obtains downlink synchronization in the control beam, and initiates a random access service beam resource application in the control beam, that is, sending a service beam resource request message to the network-side equipment in the control beam to apply for service wave speed resources.
Step 302: receiving in the control beam, by the user equipment, resource configuration information sent by the network-side equipment.

After receiving the service beam resource request message sent by the user equipment, the network-side equipment schedules the service beam for coverage of the user equipment, thereby supporting random access of the user equipment. The network-side equipment may determine the resource configuration information of the service beam according to the service beam resource request message and the current resource utilization status, and send the resource configuration information to the user equipment in the control beam. The network-side equipment schedules service beams to provide random access services for user equipment.
Step 303: initiating, by the user equipment, a random access process in a service beam of the hopping beam according to the resource configuration information.

The user equipment can learn relevant information such as the hopping period of the service beam configured by the network-side equipment according to the resource configuration information, thereby initiating a random access process in the service beam. The user equipment initiating a random access process in the service beam means: performing random access in the service beam.

According to the embodiment of the present disclosure, the user equipment applies for the service beam resources required for random access in the control beam of the hopping beam, and obtains the resource configuration information of the service beam sent by the network-side equipment in the control beam. According to the resource configuration information, the user equipment initiates random access in the service beam, thereby simplifying the control beam design, reducing the power, bandwidth and other configurations of the control beam, increasing the power configuration of the service beam, and improving the resource utilization of the communication system.

Specifically, the service beam resource request message may include: a detection sequence of the user equipment;
or
the service beam resource request message includes: a detection sequence of the user equipment and location information of the user equipment.

In this embodiment, the service beam resource request message sent by the user equipment to the network-side equipment may include the detection sequence of the user equipment, or may include both the detection sequence of the user equipment and the location information of the user equipment. If the service beam resource request message does not include the location information of the user equipment, the location information of the user equipment may be implicitly indicated by the detection sequence of the user equipment.
where the detection sequence may include one of the following:
a) first preamble sequence. The first preamble sequence may be a preamble sequence in a relevant protocol standard.
b) a second preamble sequence with a length greater than or equal to the first value; the first value can be set according to requirements. Preferably, the first value is greater than the length of the preamble sequence in the relevant protocol standard, that is, a longer preamble sequence is designed. The preamble sequence is used as a detection sequence, such as a pseudo-random (PN) sequence with a length of 2048 or 4096, or a ZC (Zadoff-chu) sequence. Each user equipment is assigned a detection sequence as the unique identifier of the user equipment, which can improve detection probability under low signal-to-noise ratio.
c) preamble sequence that has been authorized to be scrambled and with a length greater than or equal to the first value. Using authorized and scrambled special long PN codes as detection sequences, each special user equipment is assigned a detection sequence as the unique identifier of the user equipment. After the network-side equipment receives this type of detection sequence, it can increase the priority of resource allocation, ensure access services for special users. It can reduce the false detection rate, improve the detection rate of special users, and prevent malicious resource application signals.

Specifically, the location information may include at least one of the following:
1) the longitude-latitude information and elevation information of the user equipment on the ground;
2) the user equipment's wave position information. The location information of the user equipment can be the relative location information of the user equipment in the current satellite cell, such as wave position information; where the wave position refers to the ground position covered by the hopping beam each time, and the coverage area of each satellite can be composed of multiple Wave position composition.

Optionally, when the service beam resource request message does not include the location information of the user equipment, the location information of the user equipment may be indicated by the detection sequence in the service beam resource request message, or the RO time-frequency resource may be implicitly Indicate the location information of the user equipment, for example: the sending timing of the service beam resource request message indicates the location of the user equipment; when the service beam resource request message includes a detection sequence and the location information of the user equipment, the location information of the user equipment may also be implicitly indicated by the detection sequence, or implicitly indicated by RO time-frequency resource. Specifically, the service beam resource request message implicitly indicates the location information of the user equipment.

The way in which the service beam resource request message implicitly indicates the location information of the user equipment includes one of the following:
a) the detection sequence corresponds to the wave position where the user equipment is located; for example: the detection sequence of the user equipment corresponds to the wave position number of the wave position where the user equipment is located. That is, the detection sequence corresponds to the wave position where the user equipment is located, and the location information of the user equipment can be obtained according to the detection sequence and the correspondence.
b) the set of detection sequences corresponds to the wave position where the user equipment is located; for example: the set of detection sequences of the user equipment corresponds to the wave position number of the wave position where the user equipment is located, that is, one wave position corresponds to A set of detection sequences. That is, the set of detection sequences corresponds to the wave position where the user equipment is located, and the location information of the user equipment can be obtained according to the set of detection sequences and the correspondence.
c) the detection sequence and the random access channel occasion (RO) time-frequency resource respectively correspond to the wave position where the user equipment is located. For example: the wave position number of the wave position where the user equipment is located corresponds to a detection sequence and an RO time-frequency resource. That is, the detection sequence and the RO video resource respectively correspond to the wave position where the user equipment is located, and the location information of the user equipment can be obtained according to the detection sequence and the timing of sending the service beam resource request message.

In this embodiment, the location information of the user equipment is implicitly contained in the service beam resource request message. For example, the wave position where the user equipment is located may be correspond to the preamble sequence, the time-frequency resource location of the RO, or different detection sequences as pre-set in the protocol. The network-side equipment can detect the location of the user equipment when detecting the service beam resource.

In this embodiment, in order to reduce the uplink overhead when the user equipment applies for service beam resources in the control beam, the detection sequence can be used to implicitly carry the location information of the user equipment, and the wave position information (wave position refers to the area covered by each jump of the satellite beam) of the user equipment within the satellite coverage is refer to the area covered by each jump of the satellite beam) and the detection sequence correspond to each other. After the network-side equipment detects the uplink detection sequence of the user equipment, it can calculate the wave position information of the user equipment under the satellite coverage. Specifically, the satellite coverage needs to be divided into a large number of wave positions in advance. The division can be in a rectangular or square arrangement, or in a cellular hierarchical arrangement. The number of beams is related to the satellite cell range and the coverage range of a single satellite beam. The adjacent wave positions Bits will have overlapping areas to achieve complete coverage under the satellite. When configuring the system, the wave positions of the satellites are numbered in advance. For example, if 200 wave positions are divided under a satellite, then the 200 wave positions are numbered according to certain rules, and the wave position serial numbers can be obtained as: 0, 1, 2 . . . 199.

The network-side equipment can pre-match the satellite wave position serial number with the available detection sequence. It can be that one wave position corresponds to one detection sequence, one wave position can correspond to a group of detection sequences, or one wave position can correspond to one detection sequence, a RO time-frequency resource. Finally, a one-to-one correspondence between the wave position and the detection sequence, or the wave position and the detection sequence and RO resources is achieved, so that the network-side equipment can distinguish the wave position where the user equipment is based on the detection sequence and the timing of sending the random access channel.

Optionally, the location information of the user equipment includes: the wave position information of the user equipment;
prior to the sending to the network-side equipment the service beam resource request message required for the random access, the method further includes: obtaining the wave position information of the user equipment;
according to a correspondence between the wave position information and the detection sequence, determining the detection sequence corresponding to the wave position information;
where the correspondence between the wave position information and the detection sequence is sent by the network-side equipment or calculated by the user equipment.

In this embodiment, the service beam resource request message sent by the user equipment to the network-side equipment may include the wave position information of the user equipment, that is, the service beam resource request message includes the detection sequence of the user equipment and the wave position information of the user equipment. The user equipment needs to obtain its own wave position information before sending a service beam resource request message to the network-side equipment. According to the correspondence between the wave position information and the detection sequence, the detection sequence corresponding to the wave position can be obtained. The correspondence between the wave position information and the detection sequence can be used for the network-side equipment to establish a correspondence between the satellite wave position number and the available detection sequence in advance, and send the correspondence to the user equipment; or, the user equipment can pre-set the correspondence between the wave position information and the detection sequence. The correspondence between the wave position information and the detection sequence is configured, which can be set by the network-side equipment through a standard protocol. The user equipment is pre-configured with a wave position allocation strategy. The position information can be determined according to the wave position division rules, and then the user equipment can determine the position information according to the wave position division rules. Bit information searches the preset table to obtain the corresponding detection sequence.

Specifically, the obtaining the wave position information of the user equipment includes:
determining a wave position number of a wave position where the user equipment is located, based on the global navigation satellite system;
or
obtaining a wave position number of a wave position where the user equipment is located, from a downlink broadcast signal in the control beam.

In this embodiment, the first method for the user equipment to obtain its own wave position information can be: the user equipment can obtain its own position according to the Global Navigation Satellite System (GNSS), and the user equipment can obtain the position of the satellite according to the ephemeris, the user equipment is pre-configured with a wave position allocation strategy, so it can obtain the wave position number of the current satellite where it is located. Another method is that the user equipment obtains the sequence number of the current wave position from the downlink broadcast signal in the control beam, that is, the network-side equipment sends the downlink broadcast signal in the control beam, and the control beam is in the broadcast signal sent on each wave position. The information about the wave position number is different.

In this embodiment, when the user equipment controls the beam to initiate a service beam resource application, it first needs to obtain its own wave position information, and then determines the corresponding detection sequence based on the wave position information. Finally, the detection sequence can be carried when sending a service beam resource request message to the network-side equipment.

The network-side equipment can broadcast the wave position information and the preamble information available for the wave position in the control beam. After the user equipment obtains the wave position information, it selects the corresponding preamble to initiate the service beam resource application; or the network-side does not broadcast the wave position information, the user equipment knows the wave location division rules, the user equipment can obtain its own location information, calculate the current wave location sequence number based on the location information and wave location division rules, and select the preamble to apply for service beam resources. Optionally, when the network-side equipment does not broadcast wave position information and the user equipment does not know the wave position division rules, the user equipment can obtain its own location information and can carry it when sending the service beam resource request message to the network-side equipment. For this location information, the network-side equipment determines the wave location information of the user equipment based on the location information of the user equipment, and can carry the wave location information of the user equipment when sending a random access response (RAR) message to the user equipment in the random access process.

Specifically, after receiving the service beam resource request message sent by the user equipment, the network-side equipment configures the resource configuration information of the service beam for the user equipment. The resource configuration information may include:
A) resource request response message. The resource request response in the resource request response message, for example: “0” indicates that no service beam resources can be scheduled.

In the case where the resource request response message indicates that no service beam resource is schedulable, the method further includes: repeatedly sending the service beam resource request message according to a predetermined cycle.

In this embodiment, when the resource configuration information is “0”, the user equipment can wait for a period of time before reinitiating the access application (that is, sending the service beam resource request message again). The waiting time can be based on the access cycle of the control beam. Configuration, configured to be a positive integer multiple of the control beam access period.
B) service beam scheduling information. It may be status information of the allocated service beam, and may include: access time, frequency band configuration, dwell time, etc. of the service beam. For example, the resource configuration information may carry the index of the service beam, and the correspondence between the service beam index and the frequency band division may be agreed in advance in the protocol.

It should be noted that the resource configuration information may also include other required information; or the resource configuration information may include information bits reserved for subsequent function expansion, or include subsequent access mode selection instructions, etc.

After the user equipment receives the resource configuration information of the service beam sent by the network-side equipment, it initiates a random access process in the service beam according to the resource configuration information. Specifically, initiating a random access process in the service beam of the hopping beam according to the resource configuration information may include:

The random access method of the random access process is determined according to the configuration of the network-side equipment or by a user equipment's definition; according to the random access method, the random access process is performed in the service beam. When the mode is being configured by the network-side equipment, the resource configuration information includes indication information of the random access mode.

The random access method may include a 4-step access method and a 2-step access method. The random access method can be configured by the network-side equipment. For example, the network-side equipment configures the access method for the user equipment, which can be carried in the resource configuration information to inform the user equipment of the 4-step or 2-step method that needs to be selected in the service beam. One of them performs access, or performs 2-step access first and then performs 4-step access, or performs 4-step access first and then performs 2-step access, etc.

The random access mode can be defined by the user equipment, that is, the user equipment selects the random access mode independently. In this case, the user equipment independently selects the 2-step access method or the 4-step access method based on the access methods supported by the network-side equipment. Or perform 2-step access first and then perform 4-step access, or perform 4-step access first and then 2-step access, etc.

Optionally, the specific steps of the four-step access method: performing a random access process in the service beam according to the random access method may include:
1) sending a first message to the network-side equipment in the service beam, where the first message includes a physical random access channel (PRACH) signal;
2) receiving the random access response (RAR) information sent by the network-side equipment in the service beam;
3) sending a second message to the network-side equipment in the service beam, where the second message includes: user equipment identity and radio resource control (RRC) connection request;
4) receiving the random access success feedback information sent by the network-side equipment in the service beam, to resolve the competition.

Specifically, when the service beam resource request message does not include the wave position information of the user equipment, the RAR information includes the wave position information of the user equipment.

In the embodiment of the present disclosure, the wave position information of the user equipment may include the following obtaining methods:
Method 1: The network-side equipment controls to broadcast the wave position information and the preamble information available for the wave position. After the user equipment obtains the wave position information, it selects the preamble to initiate the service beam resource application;
Method 2: The network-side equipment does not broadcast wave position information, but the user equipment knows the wave position division rules. The user equipment can obtain the positioning information, calculate the current wave position number based on the positioning information and wave position division rules, and select preamble to apply for service beam resources;
Method 3: The network-side equipment does not broadcast wave position information, and the user equipment does not know the wave position division rules. The user equipment can obtain the positioning information. Then the user equipment carries the location information when initiating a service beam resource application. The network-side equipment can randomly Wave position information is fed back in the RAR during the access process.

As another optional embodiment, the specific steps of the two-step access method: performing a random access process according to the random access method may include:
1) sending a third message to the network-side equipment in the service beam, where the third message includes a PRACH signal, a user equipment identity and an RRC connection request; the third message may also include other required information.
2) receiving the random access success feedback information sent by the network-side equipment in the service beam.

The following describes the random access process of the embodiment of the present disclosure through specific embodiments.

As shown in FIG. 4, the method includes: Step 41: the user equipment obtains downlink synchronization within the control beam;
Step 42: the user equipment initiates a request for Msg1 (that is, the service beam resource request message) required for random access within the control beam. The Msg1 message can be sent multiple times.
Step 43: the user equipment receives the resource application feedback Msg2 (i.e., the resource configuration information) in the control beam. If Msg2 is not received, Msg1 is sent repeatedly;
Step 44: the user equipment initiates a random access process in the service beam according to the content of the Msg2 message (supports 4-step or 2-step random access method).
Step 45: the user equipment completes the random access.

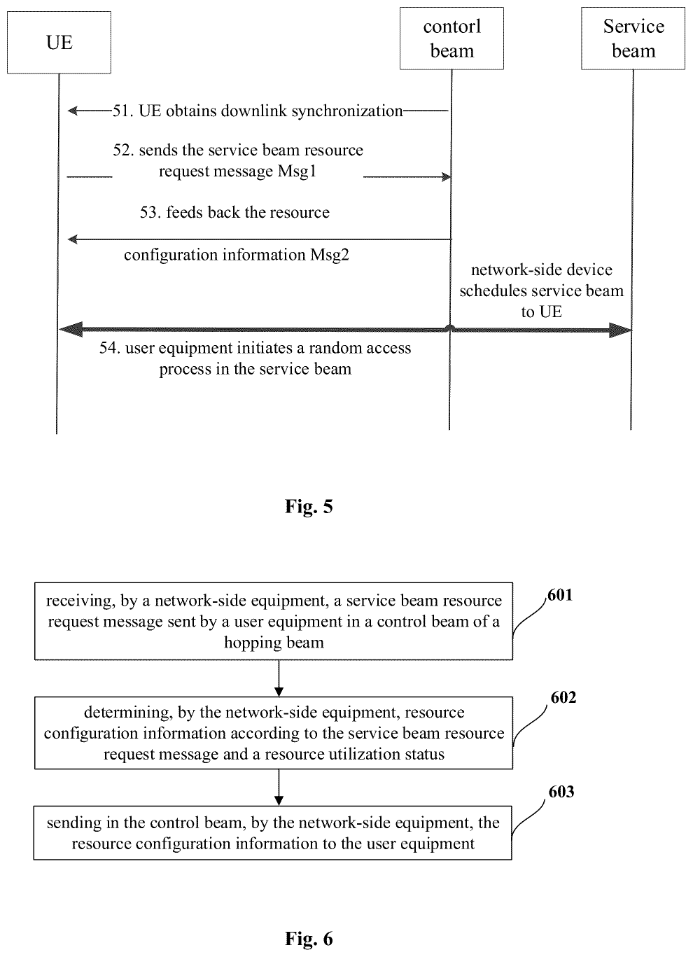

For the random access method, the execution process of the user equipment and the network-side equipment is shown in FIG. 5, including:
Step 51: the user equipment obtains downlink synchronization in the control beam;
Step 52: the user equipment applies for the service beam resources required for random access in the control beam, that is, sends the service beam resource request message Msg1;
Step 53: the network-side equipment determines the resource configuration of the service beam based on Msg1 and feeds back the resource configuration information Msg2 in the control beam. Then the user equipment receives the resource configuration information Msg2 about the service beam in the control beam;
Step 54: the network-side equipment schedules a service beam for user equipment for coverage (the scheduled service beam points to the user equipment), and the user equipment initiates a random access process in the service beam according to the content of the Msg2 message. The specific random access process can be a 4-step access method or a 2-step access method, which will not be described in detail here.

In the embodiment of the present disclosure, the user equipment applies for the service beam resources required for random access in the control beam of the hopping beam, and obtains the resource configuration information of the service beam sent by the network-side equipment in the control beam. According to the resource configuration information to initiate random access in the service beam. This embodiment simplifies the control beam design, reduces the signaling interaction requirements of the control beam, can reduce the power, bandwidth and other configurations of the control beam, saving resource overhead; it can also increase the power configuration of the service beam, thereby improving the resource utilization of the communication system.

It should be noted that the random access method provided by the embodiments of the present disclosure is not only applicable to LEO communication systems, but also applicable to geosynchronous earth orbit (GEO) communication system and medium earth orbit (MEO) communication system, which will not be described in detail here.

It should be noted that the user equipment involved in the embodiments of the present disclosure may be a device that provides voice and/or data connectivity to the user, a handheld device with a wireless connection function, or other processing equipment connected to a wireless modem, etc. The user equipment is, for example, a terminal equipment, where the wireless terminal equipment can communicate with one or more core networks (Core Network, CN) via a Radio Access Network (RAN), and the wireless terminal equipment can be a mobile terminal equipment, such as mobile phones (or “cellular” phones) and computers with mobile terminal devices, which may be, for example, portable, pocket-sized, handheld, built-in computers or mounted in vehicles, which exchange languages with the radio access network and/or data. For example, Personal Communication Service (PCS) phones, cordless phones, Session Initiated Protocol (SIP) phones, Wireless Local Loop (WLL) stations, Personal Digital Assistants, PDA) and other equipment. Wireless terminal equipment may also be called a system, a subscriber unit, a subscriber station, a mobile station, a mobile station, a remote station, or an access point, remote terminal equipment (remote terminal), access terminal equipment (access terminal), user terminal equipment (user terminal), user agent (user agent), user device (user device), are not limited in the embodiments of the present disclosure.

It is worth pointing out that the network-side equipment involved in the embodiments of the present disclosure may be satellite communication equipment, such as a base station based on satellite communication, in which the satellite and the base station may be provided integrally, or the satellite and the base station may be provided separately. It should be noted that the network-side equipment can also be an unmanned high altitude platform (HAPS) communication device, such as a drone; in addition, the network-side equipment can also be a ground communication device. When the network-side equipment is terrestrial communication equipment, it is necessary to ensure that the beam scanning method uses beam hopping, that is, the control beam and the service beam are separated.

As shown in FIG. 6, an embodiment of the present disclosure also provides a random access method, which is applied to network-side equipment, including:
Step 601: receiving, by a network-side equipment, a service beam resource request message sent by a user equipment in a control beam of a hopping beam.

The user equipment obtains downlink synchronization in the control beam, and initiates a service beam resource application required for random access in the control beam of the hopping beam, that is, sends a service beam resource request message to the network-side equipment in the control beam for To apply for service wave speed resources, the network-side equipment receives the service beam resource request message sent by the user equipment in the control beam.
Step 602: determining, by the network-side equipment, resource configuration information according to the service beam resource request message and a resource utilization status.
Step 603: sending in the control beam, by the network-side equipment, the resource configuration information to the user equipment.

After receiving the service beam resource request message sent by the user equipment, the network-side equipment schedules a service beam for coverage of the user equipment, thereby supporting random access of the user equipment. where the network-side equipment may determine the resource configuration information of the service beam according to the service beam resource request message and the current resource utilization status, and send the resource configuration information to the user equipment in the control beam. The network-side equipment schedules service beams to provide random access services for user equipment.

After receiving the resource configuration information of the service beam, the user equipment initiates a random access process in the service beam according to the resource configuration information.

In the embodiment of the present disclosure, the user equipment applies for the service beam resources required for random access in the control beam of the hopping beam, and the network-side equipment determines the resource configuration information of the service beam according to the service beam resource request and resource utilization status, and the resource configuration information is sent in the service beam; the user equipment initiates random access in the service beam according to the resource configuration information. This embodiment simplifies the control beam design, can reduce the power, bandwidth and other configurations of the control beam, and can also increase the power configuration of the service beam, thereby improving the resource utilization of the communication system.

Optionally, the service beam resource request message includes: a detection sequence of the user equipment;
or
the service beam resource request message includes: a detection sequence of the user equipment and location information of the user equipment.

In this embodiment, the service beam resource request message received by the network-side equipment may include the detection sequence of the user equipment, or may include both the detection sequence of the user equipment and the location information of the user equipment. If the service beam resource request message does not include the location information of the user equipment, the location information of the user equipment may be implicitly indicated by the detection sequence of the user equipment.

The detection sequence may include one of the following:
a) a first preamble sequence; the first preamble sequence may be a preamble sequence in relevant protocol standards.
b) a second preamble sequence with a length greater than or equal to the first value; the first value is greater than the length of the preamble sequence in the relevant protocol standard, that is, a longer preamble sequence is designed as the detection sequence, such as a PN with a length of 2048 or 4096 Sequence, ZC sequence, each user equipment is assigned a detection sequence, which serves as the unique identifier of the user equipment, which can improve the detection probability under low signal-to-noise ratio.
c) preamble sequence that has been authorized to be scrambled and with a length greater than or equal to the first value. Using authorized and scrambled special long PN codes as detection sequences, each special user equipment is assigned a detection sequence as the unique identifier of the user equipment. After the network-side equipment receives this type of detection sequence, it can increase the priority of resource allocation, ensuring access services for special users. It can reduce the false detection rate, improve the detection rate of special users, and prevent malicious resource application signals.

Optionally, the location information includes at least one of the following:
the user equipment's longitude-latitude information and elevation information on the ground;
the user equipment's wave position information. The location information of the user equipment can be the relative location information of the user equipment in the current satellite cell, such as wave position information; where the wave position refers to the ground position covered by the hopping beam each time, and the coverage area of each satellite can be composed of multiple Wave position composition.

Optionally, when the service beam resource request message does not include the location information of the user equipment, the location information of the user equipment may be indicated by the detection sequence in the service beam resource request message, or the RO time-frequency resource may be hidden. The formula indicates the location information of the user equipment, for example, the sending timing of the service beam resource request message indicates the location of the user equipment; when the service beam resource request message includes the detection sequence and the location information of the user equipment, the location information of the user equipment may also be implicitly indicated by the detection sequence or implicitly indicated by RO time-frequency resource. Specifically, the service beam resource request message implicitly indicates the location information of the user equipment.

The way in which the service beam resource request message implicitly indicates the location information of the user equipment includes one of the following:
a) the detection sequence corresponds to the wave position where the user equipment is located; for example: the detection sequence of the user equipment corresponds to the wave position number of the wave position where the user equipment is located.
b) the set of detection sequences corresponds to the wave position where the user equipment is located; for example: the set of detection sequences of the user equipment corresponds to the wave position number of the wave position where the user equipment is located, that is, one wave position corresponds to a set of detection sequences.
c) the detection sequence and the random access channel timing RO time-frequency resource respectively correspond to the wave position where the user equipment is located. For example: the wave position number of the wave position where the user equipment is located corresponds to a detection sequence and an RO time-frequency resource.

In this embodiment, the location information of the user equipment is implicit in the service beam resource request message. For example, the wave position where the user equipment is located and the preamble sequence, the time-frequency resource location of the RO, or different detection sequences can be pre-set in the protocol. Corresponding to the set, etc., the network-side equipment can detect the location of the user equipment when detecting the service beam resource.

Optionally, the location information of the user equipment includes: wave position information of the user equipment;
prior to the receiving the service beam resource request message sent by the user equipment in the control beam of the hopping beam, the method further includes:
establishing a correspondence between the wave position information and the detection sequence;
sending the correspondence to the user equipment.

In this embodiment, in order to reduce the uplink overhead when the user equipment applies for service beam resources in the control beam, the detection sequence can be used to implicitly carry the location information of the user equipment, and the wave position information of the user equipment within the satellite coverage is combined with the detection sequence. Corresponding to each other, after the network-side equipment detects the uplink detection sequence of the user equipment, it can calculate the wave position information of the user equipment under satellite coverage. Specifically, the network-side equipment can pre-divide the satellite coverage into a large number of wave positions. The division can be in a rectangular or square arrangement, or in a hierarchical cellular arrangement. The number of beams is related to the satellite cell range and the coverage of a single satellite beam. Adjacent wave positions will have overlapping areas to achieve complete coverage under the satellite. When configuring the system, the wave positions of the satellites are numbered in advance. For example, if 200 wave positions are divided under a satellite, then the 200 wave positions are numbered according to certain rules, and the wave position serial numbers can be obtained as: 0, 1, 2 . . . 199.

The network-side equipment can pre-match the satellite wave position serial number with the available detection sequence. It can be that one wave position corresponds to one detection sequence, one wave position can correspond to a group of detection sequences, or one wave position can correspond to one detection sequence, a RO time-frequency resource. Finally, a one-to-one correspondence between the wave position and the detection sequence, or the wave position and the detection sequence and RO resources is achieved, so that the network-side equipment can distinguish the wave position where the user equipment is based on the detection sequence and the timing of sending the random access channel.

Optionally, the method further includes: sending a downlink broadcast signal in the control beam, where the downlink broadcast signal includes the wave position number of the control beam.

When the service beam resource request message includes the wave position information of the user equipment, the wave position information may be the wave position number determined by the user equipment according to GNSS, or may be a downlink broadcast sent by the network-side equipment in the control beam. The information about the wave position number in the broadcast signal sent by the control beam on each wave position is different. When the user equipment controls the beam to initiate a service beam resource application, it first needs to obtain its own wave position information, and then determines the corresponding detection sequence based on the wave position information. Finally, it carries the detection sequence when sending the service beam resource request message to the network-side equipment.

After receiving the service beam resource request message sent by the user equipment, the network-side equipment configures the resource configuration information of the service beam for the user equipment. Optionally, the resource configuration information includes:
A) resource request response message; the resource request response in the resource application response message, for example: “0” indicates that no service beam resources can be scheduled.
B) service beam scheduling information, may include: access time, frequency band configuration, dwell time, etc. of the service beam. For example, the resource configuration information may carry the index of the service beam, and the correspondence between the service beam index and the frequency band division may be agreed in advance in the protocol.

It should be noted that the resource configuration information may also include other required information; or the resource configuration information may include information bits reserved for subsequent function expansion, or include subsequent access mode selection instructions, etc.

Optionally, after sending the resource configuration information to the user equipment in the control beam, the method further includes:

The random access process initiated by the user equipment is performed in the service beam of the hopping beam.

The random access method may include a 4-step access method and a 2-step access method. The random access mode can be configured for the network-side equipment. For example, the network-side equipment configures the access mode for the user equipment, and can be carried in the resource configuration information to inform the user equipment of the 4 or 2 steps that need to be selected in the service beam. One of the step methods is used for access, or the 2-step access method is performed first and then the 4-step access method is performed, or the 4-step access method is performed first and then the 2-step access method is performed, etc.

The random access method can be customized by the user equipment, that is, the user equipment selects independently. In this case, the user equipment independently selects the 2-step access method or the 4-step access method according to the access methods supported by the network-side equipment, or perform 2-step access firstly and then 4-step access, or perform 4-step access first and then 2-step access, etc.

The performing the random access process initiated by user equipment in the service beam of the hopping beam include:
1) receive the first message sent by the user equipment in the service beam, where the first message includes a physical random access channel (PRACH) signal;
2) according to the first message, send random access response (RAR) information to the user equipment in the service beam;
3) receive the second message sent by the user equipment in the service beam, where the second message includes: user equipment identity and radio resource control (RRC) connection request;
4) send random access success feedback information to the user equipment in the service beam.

Optionally, in the case where the service beam resource request message does not include the wave position information of the user equipment, the RAR information includes the wave position information of the user equipment.

In the embodiment of the present disclosure, the wave position information of the user equipment may include the following acquisition methods:
Method 1: The network-side equipment controls the beam to broadcast the information of the wave position and the preamble information available for the wave position. After the user equipment obtains the wave position information, it selects the preamble to initiate the service beam resource application;
Method 2: The network-side equipment does not broadcast wave position information, but the user equipment knows the wave position division rules. The user equipment can obtain the positioning information, calculate the current wave position number based on the positioning information and wave position division rules, and select preamble to apply for service beam resources;
Method 3: The network-side equipment does not broadcast wave position information, and the user equipment does not know the wave position division rules. The user equipment can obtain the positioning information. Then the user equipment carries the location information when initiating a service beam resource application. The network-side equipment can randomly Wave position information is fed back in the RAR during the access process.

The performing the random access process initiated by user equipment in the service beam of the hopping beam include:
1) receive the third message sent by the user equipment in the service beam, where the third message includes a PRACH signal, user equipment identity and RRC connection request;
2) send random access success feedback information to the user equipment in the service beam.

The following describes the random access process of the embodiment of the present disclosure through specific embodiments.

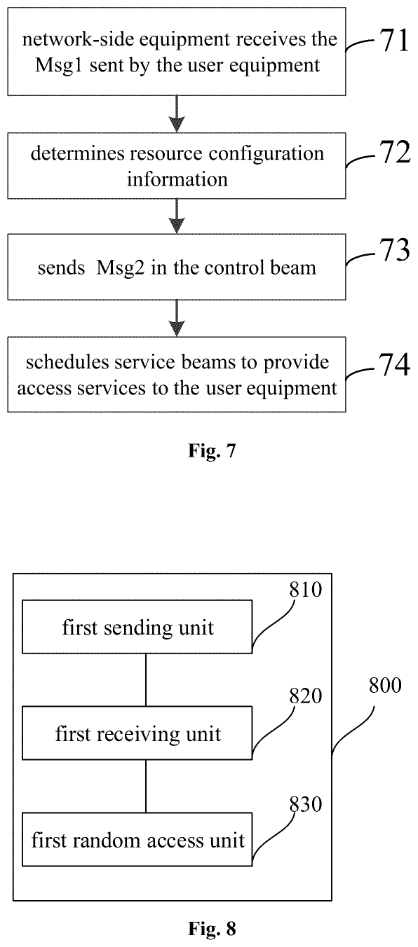

As shown in FIG. 7, it includes: Step 71: The network-side equipment receives the application Msg1 for the service beam resource sent by the user equipment in the control beam, and successfully detects it once to determine that there is an access request;
Step 72: The network-side equipment determines whether to allocate service beam resources to the user equipment's service beam resource request and determines resource configuration information based on Msg1 and the current resource utilization status;
Step 73: The network-side equipment sends resource application feedback Msg2 (i.e., the resource configuration information) in the control beam;
Step 74: The network-side equipment schedules service beams to provide access services to the user equipment.

For the random access method, the complete execution process of the user equipment and the network-side equipment is shown in FIG. 5, which will not be described again here.

In an embodiment of the present disclosure, the network-side equipment receives the service beam resource request message sent by the user equipment in the control beam, determines the resource configuration information of the service beam according to the service beam resource request and the resource utilization status, and sends the resources in the control beam Configuration information; the user equipment initiates random access in the service beam according to the resource configuration information. This embodiment simplifies the control beam design, can reduce the power, bandwidth and other configurations of the control beam, and can also increase the power configuration of the service beam, thereby improving the resource utilization of the communication system.

The above embodiment introduces the positioning method of the present disclosure. The following embodiment will further describe the corresponding device in conjunction with the accompanying drawings.

Specifically, as shown in FIG. 8, the random access apparatus 800 of the embodiment of the present disclosure is applied to a user equipment and includes:
a first sending unit 810, configured to send to a network-side equipment, a service beam resource request message required for a random access, in a control beam of a hopping beam;
a first receiving unit 820, configured to receive in the control beam, resource configuration information sent by the network-side equipment; and
a first random access unit 830, configured to initiate a random access process in a service beam of the hopping beam according to the resource configuration information.

Optionally, the service beam resource request message includes: a detection sequence of the user equipment;
or
the service beam resource request message includes: a detection sequence of the user equipment and location information of the user equipment.

Optionally, the detection sequence includes one of the following:
a first preamble sequence;
a second preamble sequence with a length greater than or equal to a first value;
a third preamble sequence authorized to be scrambled and with a length greater than or equal to a first value.

Optionally, the location information includes at least one of the following:
the user equipment's longitude-latitude information and elevation information on the ground;
the user equipment's wave position information.

Optionally, the service beam resource request message implicitly indicates the location information of the user equipment;
the way in which the service beam resource request message implicitly indicates the location information of the user equipment includes one of the following:
the detection sequence corresponds to a wave position where the user equipment is located;
a set of detection sequences corresponds to the wave position where the user equipment is located;
the detection sequence and a random access channel occasion (RO) time-frequency resource correspond to a wave position where the user equipment is located.

Optionally, the location information of the user equipment includes: the wave position information of the user equipment;
the apparatus further includes:
a first obtaining unit, configured to obtain the wave position information of the user equipment;
a second determining unit, configured to, according to a correspondence between the wave position information and the detection sequence, determine the detection sequence corresponding to the wave position information;
where the correspondence between the wave position information and the detection sequence is sent by the network-side equipment or calculated by the user equipment.

Optionally, the first obtaining unit is further configured to:
determine a wave position number of a wave position where the user equipment is located, based on the global navigation satellite system;
or
obtain a wave position number of a wave position where the user equipment is located, from a downlink broadcast signal in the control beam.

Optionally, the resource configuration information includes:
a resource request response message;
service beam scheduling information.

Optionally, the service beam scheduling information includes: an access time, a frequency band configuration and a residence time of the service beam.

Optionally, when the resource request response message indicates that no service beam resource is schedulable, the device further includes:
a third sending unit, configured to repeatedly send the service beam resource request message according to a predetermined period.

Optionally, the first random access unit includes:
a first determining sub-unit, configured to determine a random access mode of the random access process according to a configuration of the network-side equipment or by a user equipment's definition;
a first access sub-unit, configured to perform a random access process in the service beam, according to the random access method;
where when the random access mode is configured by the network-side equipment, the resource configuration information includes indication information of the random access mode.

Optionally, the first access sub-unit is further configured to:
send a first message to the network-side equipment in the service beam, where the first message includes a physical random access channel (PRACH) signal;
receive, in the service beam, random access response (RAR) information sent by the network-side equipment;
send a second message to the network-side equipment in the service beam, where the second message includes: a user equipment identity and a radio resource control (RRC) connection request; and
receive, in the service beam, random access success feedback information sent by the network-side equipment.

Optionally, the access sub-unit is further configured to:
send a third message to the network-side equipment in the service beam, where the third message includes a PRACH signal, a user equipment identity and an RRC connection request;
receive, in the service beam, random access success feedback information sent by the network-side equipment.

Optionally, when the service beam resource request message does not include wave position information of the user equipment, the RAR information includes the wave position information of the user equipment.

In the embodiment of the present disclosure, the user equipment applies for the service beam resources required for random access in the control beam of the hopping beam, and obtains the resource configuration information of the service beam sent by the network-side equipment in the control beam. According to the resource configuration information to initiate random access in the service beam. This embodiment simplifies the control beam design, reduces the signaling interaction requirements of the control beam, can reduce the power, bandwidth and other configurations of the control beam, saving resource overhead; it can also increase the power configuration of the service beam, thereby improving the resource utilization of the communication system.

It should be noted here that the above-mentioned device provided by the embodiments of the present disclosure can implement all the method steps implemented by the above-mentioned method embodiments applied to user equipment, and can achieve the same technical effect. No further explanation will be given here. The same parts and beneficial effects as those in the method embodiment will be described in detail.

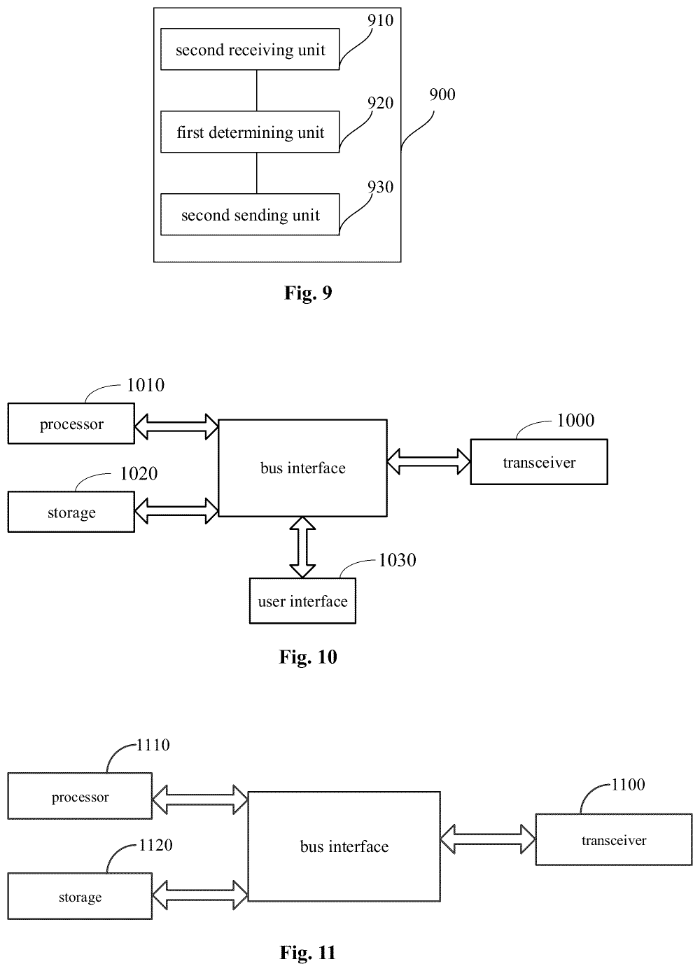

Specifically, as shown in FIG. 9, this embodiment of the present disclosure also provides a random access device 900, which is applied to network-side equipment and includes:
a second receiving unit 910, configured to receive a service beam resource request message sent by a user equipment in a control beam of a hopping beam;
a first determining unit 920, configured to determine resource configuration information according to the service beam resource request message and a resource utilization status; and
a second sending unit 930, configured to send in the control beam the resource configuration information to the user equipment.

Optionally, the service beam resource request message includes: a detection sequence of the user equipment;
or
the service beam resource request message includes: a detection sequence of the user equipment and location information of the user equipment.

Optionally, the detection sequence includes one of the following:
a first preamble sequence;
a second preamble sequence with a length greater than or equal to a first value;
a third preamble sequence authorized to be scrambled and with a length greater than or equal to a first value.

Optionally, the location information includes at least one of the following:
the user equipment's longitude-latitude information and elevation information on the ground;
the user equipment's wave position information.

Optionally, the service beam resource request message implicitly indicates the location information of the user equipment;
the way in which the service beam resource request message implicitly indicates the location information of the user equipment includes one of the following:
the detection sequence corresponds to a wave position where the user equipment is located;
a set of detection sequences corresponds to the wave position where the user equipment is located;
the detection sequence and a random access channel occasion (RO) time-frequency resource correspond to a wave position where the user equipment is located.

Optionally, the location information of the user equipment includes: the wave position information of the user equipment;
the apparatus further includes:
an establishing unit, configured to establish a correspondence between the wave position information and the detection sequence;
a fourth sending unit, configured to send the correspondence to the user equipment.

Optionally, the random access apparatus further includes:
a fifth sending unit, configured to send a downlink broadcast signal in the control beam, where the downlink broadcast signal includes the wave position number of the control beam.

Optionally, the resource configuration information includes:
a resource request response message;
service beam scheduling information.
Optionally, the service beam scheduling information includes: an access time, a frequency band configuration and a residence time of the service beam.

Optionally, the random access apparatus further includes:
a second random access unit, configured to perform the random access process initiated by the user equipment in the service beam of the hopping beam.

Optionally, the second random access unit is further configured to:
receive a first message sent by the user equipment in the service beam, where the first message includes a physical random access channel (PRACH) signal;
according to the first message, send random access response (RAR) information to the user equipment in the service beam;
receive a second message sent by the user equipment in the service beam, where the second message includes: a user equipment identity and a radio resource control (RRC) connection request; and
send random access success feedback information to the user equipment in the service beam.

Optionally, the second random access unit is further configured to:
receive a third message sent by the user equipment in the service beam, where the third message includes a PRACH signal, a user equipment identity and an RRC connection request;
send random access success feedback information to the user equipment in the service beam.

Optionally, when the service beam resource request message does not include wave position information of the user equipment, the RAR information includes the wave position information of the user equipment.

In the embodiment of the present disclosure, the user equipment applies for the service beam resources required for random access in the control beam of the hopping beam, and the network-side equipment determines the resource configuration information of the service beam according to the service beam resource request and resource utilization status, and performs the control The resource configuration information is sent in the service beam; the user equipment initiates random access in the service beam according to the resource configuration information. This embodiment simplifies the control beam design, can reduce the power, bandwidth and other configurations of the control beam, and can also increase the power configuration of the service beam, thereby improving the resource utilization of the communication system.

It should be noted here that the above-mentioned device provided by the embodiment of the present disclosure can implement all the method steps implemented by the above-mentioned method embodiment applied to network-side equipment, and can achieve the same technical effect. This embodiment will no longer be discussed here. The same parts and beneficial effects as those in the method embodiments will be described in detail.

It should be noted that the division of units in the embodiment of the present disclosure is schematic and is only a logical function division. In actual implementation, there may be other division methods. In addition, each functional unit in various embodiments of the present disclosure may be integrated into one processing unit, or each unit may exist physically alone, or two or more units may be integrated into one unit. The above integrated units can be implemented in the form of hardware or software functional units.

If the integrated unit is implemented in the form of a software functional unit and sold or used as an independent product, it may be stored in a processor-readable storage medium. Based on this understanding, the technical solution of the present disclosure is essentially or contributes to the relevant technology, or all or part of the technical solution can be embodied in the form of a software product, and the computer software product is stored in a storage medium, It includes several instructions to cause a computer device (which can be a personal computer, a server, or a network device, etc.) or a processor to execute all or part of the steps of the methods described in various embodiments of the present disclosure. The aforementioned storage media include: U disk, mobile hard disk, Read-Only Memory (ROM), Random Access Memory (RAM), magnetic disk or optical disk and other media that can store program code.

As shown in FIG. 10, an embodiment of the present disclosure also provides a user equipment, including: a storage 1020, a transceiver 1000, and a processor 1010; where the storage 1020 is used to store computer programs; the transceiver 1000 is used to Under the control of the processor 1010, the processor 1010 sends and receives data and performs the following operations:
sending to a network-side equipment, a service beam resource request message required for a random access, in a control beam of a hopping beam;
receiving in the control beam, resource configuration information sent by the network-side equipment; and
the processor 1010 is configured to read the computer program in the storage to perform:
initiating a random access process in a service beam of the hopping beam according to the resource configuration information.

Optionally, the service beam resource request message includes: a detection sequence of the user equipment;
or
the service beam resource request message includes: a detection sequence of the user equipment and location information of the user equipment.

Optionally, the detection sequence includes one of the following:
a first preamble sequence;
a second preamble sequence with a length greater than or equal to a first value;
a third preamble sequence authorized to be scrambled and with a length greater than or equal to a first value.

Optionally, the location information includes at least one of the following:
the user equipment's longitude-latitude information and elevation information on the ground;
the user equipment's wave position information.

Optionally, the service beam resource request message implicitly indicates the location information of the user equipment;
the way in which the service beam resource request message implicitly indicates the location information of the user equipment includes one of the following:
the detection sequence corresponds to a wave position where the user equipment is located;
a set of detection sequences corresponds to the wave position where the user equipment is located;
the detection sequence and a random access channel occasion (RO) time-frequency resource correspond to a wave position where the user equipment is located.

Optionally, the location information of the user equipment includes: the wave position information of the user equipment;
prior to the sending to the network-side equipment the service beam resource request message required for the random access, the processor 1010 is further configured to read the computer program in the storage to perform:
obtaining the wave position information of the user equipment;
according to a correspondence between the wave position information and the detection sequence, determining the detection sequence corresponding to the wave position information;
where the correspondence between the wave position information and the detection sequence is sent by the network-side equipment or calculated by the user equipment.

Optionally, the obtaining the wave position information of the user equipment includes:
determining a wave position number of a wave position where the user equipment is located, based on the global navigation satellite system;
or
obtaining a wave position number of a wave position where the user equipment is located, from a downlink broadcast signal in the control beam.

Optionally, the resource configuration information includes:
a resource request response message;
service beam scheduling information.

Optionally, the service beam scheduling information includes: an access time, a frequency band configuration and a residence time of the service beam.

Optionally, when the resource request response message indicates that no service beam resource is schedulable, the transceiver is further configured to perform:
repeatedly sending the service beam resource request message according to a predetermined period.

Optionally, the initiating the random access process in the service beam of the hopping beam according to the resource configuration information includes:
determining a random access mode of the random access process according to a configuration of the network-side equipment or by a user equipment's definition;
performing a random access process in the service beam, according to the random access method;
where when the random access mode is configured by the network-side equipment, the resource configuration information includes indication information of the random access mode.

Optionally, the performing the random access process in the service beam according to the random access method includes:
sending a first message to the network-side equipment in the service beam, where the first message includes a physical random access channel (PRACH) signal;
receiving, in the service beam, random access response (RAR) information sent by the network-side equipment;
sending a second message to the network-side equipment in the service beam, where the second message includes: a user equipment identity and a radio resource control (RRC) connection request; and
receiving, in the service beam, random access success feedback information sent by the network-side equipment.

Optionally, the performing the random access process according to the random access mode includes:
sending a third message to the network-side equipment in the service beam, where the third message includes a PRACH signal, a user equipment identity and an RRC connection request;
receiving, in the service beam, random access success feedback information sent by the network-side equipment.

Optionally, when the service beam resource request message does not include wave position information of the user equipment, the RAR information includes the wave position information of the user equipment.

In the embodiment of the present disclosure, the user equipment applies for the service beam resources required for random access in the control beam of the hopping beam, and obtains the resource configuration information of the service beam sent by the network-side equipment in the control beam. According to the resource configuration information to initiate random access in the service beam. This embodiment simplifies the control beam design, reduces the signaling interaction requirements of the control beam, can reduce the power, bandwidth and other configurations of the control beam, saving resource overhead; it can also increase the power configuration of the service beam, thereby improving the resource utilization of the communication system Rate.

It should be noted that in FIG. 10, the bus architecture may include any number of interconnected buses and bridges, specifically one or more processors represented by the processor 1010 and various circuits of the storage represented by the storage 1020 are linked together. The bus architecture can also link together various other circuits such as peripherals, voltage regulators, and power management circuits, which are all well known in the art and therefore will not be described further herein. The bus interface provides the interface. Transceiver 1000 may be a plurality of elements, including a transmitter and a transceiver, providing a unit for communicating with various other devices over a transmission medium. For different user equipment, the user interface 1030 can also be an interface that can connect external and internal required equipment. The connected equipment includes but is not limited to a keypad, a display, a speaker, a microphone, a joystick, etc. The processor 1010 is responsible for managing the bus architecture and general processing, and the storage 1020 can store data used by the processor 1010 when performing operations.

Optionally, the processor 1010 may be a central processing unit (CPU), an application specific integrated circuit (ASIC), a field programmable gate array (FPGA) or Complex Programmable Logic Device (CPLD), the processor can also adopt a multi-core architecture.

The processor is configured to execute any of the methods provided by the embodiments of the present disclosure according to the obtained executable instructions by calling the computer program stored in the storage. The processor and storage can also be physically separated.

It should be noted here that the above-mentioned user equipment provided by the embodiments of the present disclosure can implement all the method steps implemented by the above-mentioned method embodiments applied to user equipment, and can achieve the same technical effect. This embodiment will no longer be discussed here. The same parts and beneficial effects as those in the method embodiments will be described in detail.

As shown in FIG. 11, the embodiment of the present disclosure also provides a network-side equipment, including: a storage 1120, a transceiver 1100, and a processor 1110; where the storage 1120 is used to store computer programs; the transceiver 1100 is used to Send and receive data under the control of the processor 1110 and perform:
receiving a service beam resource request message sent by a user equipment in a control beam of a hopping beam;
the processor 1110 is configured to read the computer program in the storage to perform:
determining resource configuration information according to the service beam resource request message and a resource utilization status; and
the transceiver 1100 is further configured to perform:
sending in the control beam, the resource configuration information to the user equipment.

Optionally, the service beam resource request message includes: a detection sequence of the user equipment;
or
the service beam resource request message includes: a detection sequence of the user equipment and location information of the user equipment.

Optionally, the detection sequence includes one of the following:
a first preamble sequence;
a second preamble sequence with a length greater than or equal to a first value;
a third preamble sequence authorized to be scrambled and with a length greater than or equal to a first value.

Optionally, the location information includes at least one of the following:
the user equipment's longitude-latitude information and elevation information on the ground;
the user equipment's wave position information.

Optionally, the service beam resource request message implicitly indicates the location information of the user equipment;
the way in which the service beam resource request message implicitly indicates the location information of the user equipment includes one of the following:
the detection sequence corresponds to a wave position where the user equipment is located;
a set of detection sequences corresponds to the wave position where the user equipment is located;
the detection sequence and a random access channel occasion (RO) time-frequency resource correspond to a wave position where the user equipment is located.

Optionally, the location information of the user equipment includes: the wave position information of the user equipment;
prior to the receiving the service beam resource request message sent by the user equipment in the control beam of the hopping beam, the processor 1110 is further configured to perform:
establishing a correspondence between the wave position information and the detection sequence;
the transceiver is further configured to perform:
sending the correspondence to the user equipment.

Optionally, the transceiver 1100 is further configured to:
sending a downlink broadcast signal in the control beam, where the downlink broadcast signal includes the wave position number of the control beam.

Optionally, the resource configuration information includes:
a resource request response message;
service beam scheduling information.

Optionally, the service beam scheduling information includes: an access time, a frequency band configuration and a residence time of the service beam.

Optionally, subsequent to the sending the resource configuration information to the user equipment in the control beam, the processor 1110 is further configured to perform:
performing the random access process initiated by the user equipment in the service beam of the hopping beam.

Optionally, the performing the random access process initiated by user equipment in the service beam of the hopping beam includes:
receiving a first message sent by the user equipment in the service beam, where the first message includes a physical random access channel (PRACH) signal;
according to the first message, sending random access response (RAR) information to the user equipment in the service beam;
receiving a second message sent by the user equipment in the service beam, where the second message includes: a user equipment identity and a radio resource control (RRC) connection request; and
sending random access success feedback information to the user equipment in the service beam.

Optionally, the performing the random access process initiated by user equipment in the service beam of the hopping beam includes:
receiving a third message sent by the user equipment in the service beam, where the third message includes a PRACH signal, a user equipment identity and an RRC connection request;
sending random access success feedback information to the user equipment in the service beam.

Optionally, when the service beam resource request message does not include wave position information of the user equipment, the RAR information includes the wave position information of the user equipment.

In an embodiment of the present disclosure, the network-side equipment receives the service beam resource request message sent by the user equipment in the control beam, determines the resource configuration information of the service beam according to the service beam resource request and the resource utilization status, and sends the resources in the control beam Configuration information; the user equipment initiates random access in the service beam according to the resource configuration information. This embodiment simplifies the control beam design, can reduce the power, bandwidth and other configurations of the control beam, and can also increase the power configuration of the service beam, thereby improving the resource utilization of the communication system.

In FIG. 11, the bus architecture may include any number of interconnected buses and bridges, specifically one or more processors represented by processor 1110 and various circuits of the storage represented by storage 1120 are linked together. The bus architecture can also link together various other circuits such as peripherals, voltage regulators, and power management circuits, which are all well known in the art and therefore will not be described further herein. The bus interface provides the interface. Transceiver 1100 may be a plurality of elements, including a transmitter and a transceiver, providing a unit for communicating with various other devices over a transmission medium. The processor 1110 is responsible for managing the bus architecture and general processing, and the storage 1120 can store data used by the processor 1110 when performing operations.

The processor 1110 may be a central processing unit (CPU), an application specific integrated circuit (ASIC), a field programmable gate array (FPGA) or a complex programmable logic device (CPLD), the processor can also adopt a multi-core architecture.

It should be noted here that the above-mentioned network-side equipment provided by the embodiment of the present disclosure can implement all the method steps implemented by the above-mentioned method embodiment applied to the network-side equipment, and can achieve the same technical effect. This article will no longer be explained here. The parts and beneficial effects in the embodiments that are the same as those in the method embodiments will be described in detail.

In addition, specific embodiments of the present disclosure also provide a processor-readable storage medium on which a computer program is stored, where when the program is executed by the processor, the steps of the above random access method are implemented, which can achieve the same technical effect. To avoid repetition, they will not be described again here. where the readable storage medium may be any available medium or data storage device that the processor can access, including but not limited to magnetic storage (such as floppy disk, hard disk, magnetic tape, magneto-optical disk (MO), etc.), optical storage (such as CD, DVD, BD, HVD, etc.), and semiconductor memory (such as ROM, EPROM, EEPROM, non-volatile memory (NAND FLASH), solid state drive (SSD)), etc.

Those skilled in the art will appreciate that embodiments of the present disclosure may be provided as methods, systems, or computer program products. Accordingly, the present disclosure may take the form of an entirely hardware embodiment, an entirely software embodiment, or an embodiment that combines software and hardware aspects. Furthermore, the present disclosure may take the form of a computer program product embodied on one or more computer-usable storage media (including, but not limited to, magnetic disk storage, optical storage, and the like) having computer-usable program code embodied therein.

The present disclosure is described with reference to flowchart illustrations and/or block diagrams of methods, apparatus (systems), and computer program products according to embodiments of the disclosure. It will be understood that each process and/or block in the flowchart illustrations and/or block diagrams, and combinations of processes and/or blocks in the flowchart illustrations and/or block diagrams, can be implemented by computer-executable instructions. These computer-executable instructions may be provided to a processor of a general-purpose computer, special-purpose computer, embedded processor, or other programmable data processing device to produce a machine such that the instructions executed by the processor of the computer or other programmable data processing device produce Means for implementing the functions specified in a process or processes in a flowchart and/or in a block or blocks in a block diagram.

These processor-executable instructions may also be stored in a processor-readable memory that causes a computer or other programmable data processing apparatus to operate in a particular manner, such that the generation of instructions stored in the processor-readable memory includes the manufacture of the instruction means The instruction device implements the functions specified in one process or multiple processes of the flowchart and/or one block or multiple blocks of the block diagram.

These processor-executable instructions may also be loaded onto a computer or other programmable data processing device, causing a series of operational steps to be performed on the computer or other programmable device to produce computer-implemented processing, thereby causing the computer or other programmable device to The instructions that are executed provide steps for implementing the functions specified in the process or processes of the flowchart diagrams and/or the block or blocks of the block diagrams.

Obviously, those skilled in the art can make various changes and modifications to the present disclosure without departing from the spirit and scope of the disclosure. In this way, if these modifications and variations of the present disclosure fall within the scope of the claims of the present disclosure and equivalent technologies, the present disclosure is also intended to include these modifications and variations.

1. A random access method, comprising:
sending to a network-side equipment, by a user equipment, a service beam resource request message required for a random access, in a control beam of a hopping beam;
receiving in the control beam, by the user equipment, resource configuration information sent by the network-side equipment; and
initiating, by the user equipment, a random access process in a service beam of the hopping beam according to the resource configuration information.

2. The method according to claim 1, wherein the service beam resource request message comprises: a detection sequence of the user equipment;
or
the service beam resource request message comprises: a detection sequence of the user equipment and location information of the user equipment.

3. The method according to claim 2, wherein the detection sequence comprises one of the following:
a first preamble sequence;
a second preamble sequence with a length greater than or equal to a first value;
a third preamble sequence authorized to be scrambled and with a length greater than or equal to a first value.

4. The method according to claim 2, wherein the location information comprises at least one of the following:
the user equipment's longitude-latitude information and elevation information on the ground;
the user equipment's wave position information.

5. The method according to claim 2, wherein the service beam resource request message implicitly indicates the location information of the user equipment;
the way in which the service beam resource request message implicitly indicates the location information of the user equipment comprises one of the following:
the detection sequence corresponds to a wave position where the user equipment is located;
a set of detection sequences corresponds to the wave position where the user equipment is located;
the detection sequence and a random access channel occasion (RO) time-frequency resource correspond to a wave position where the user equipment is located.

6. The method according to claim 4, wherein the location information of the user equipment comprises: the wave position information of the user equipment;
prior to the sending to the network-side equipment the service beam resource request message required for the random access, the method further comprises:
obtaining the wave position information of the user equipment;
according to a correspondence between the wave position information and the detection sequence, determining the detection sequence corresponding to the wave position information;
wherein the correspondence between the wave position information and the detection sequence is sent by the network-side equipment or calculated by the user equipment;
wherein the obtaining the wave position information of the user equipment comprises:
determining a wave position number of a wave position where the user equipment is located, based on the global navigation satellite system;
or
obtaining a wave position number of a wave position where the user equipment is located, from a downlink broadcast signal in the control beam.

7. (canceled)

8. The method according to claim 1, wherein the resource configuration information comprises:
a resource request response message;
service beam scheduling information;
wherein the service beam scheduling information comprises: an access time, a frequency band configuration and a residence time of the service beam;
when the resource request response message indicates that no service beam resource is schedulable, the method further comprises:
repeatedly sending the service beam resource request message according to a predetermined period.

9.-10. (canceled)

11. The method according to claim 1, wherein the initiating the random access process in the service beam of the hopping beam according to the resource configuration information comprises:
determining a random access mode of the random access process according to a configuration of the network-side equipment or by a user equipment's definition;
performing a random access process in the service beam, according to the random access method;
wherein when the random access mode is configured by the network-side equipment, the resource configuration information comprises indication information of the random access mode.

12. The method according to claim 11, wherein the performing the random access process in the service beam according to the random access method comprises:
sending a first message to the network-side equipment in the service beam, wherein the first message comprises a physical random access channel (PRACH) signal;
receiving, in the service beam, random access response (RAR) information sent by the network-side equipment;
sending a second message to the network-side equipment in the service beam, wherein the second message comprises: a user equipment identity and a radio resource control (RRC) connection request; and
receiving, in the service beam, random access success feedback information sent by the network-side equipment;
wherein when the service beam resource request message does not include wave position information of the user equipment, the RAR information comprises the wave position information of the user equipment;
or
the performing the random access process according to the random access mode comprises:
sending a third message to the network-side equipment in the service beam, wherein the third message comprises a PRACH signal, a user equipment identity and an RRC connection request;
receiving, in the service beam, random access success feedback information sent by the network-side equipment.

13.-14. (canceled)

15. A random access method, comprises:
receiving, by a network-side equipment, a service beam resource request message sent by a user equipment in a control beam of a hopping beam;
determining, by the network-side equipment, resource configuration information according to the service beam resource request message and a resource utilization status; and
sending in the control beam, by the network-side equipment, the resource configuration information to the user equipment.

16. The method according to claim 15, wherein the service beam resource request message comprises: a detection sequence of the user equipment;
or
the service beam resource request message comprises: a detection sequence of the user equipment and location information of the user equipment.

17. The method according to claim 16, wherein the detection sequence comprises one of the following:
a first preamble sequence;
a second preamble sequence with a length greater than or equal to a first value;
a third preamble sequence authorized to be scrambled and with a length greater than or equal to a first value.

18. The method according to claim 16, wherein the location information comprises at least one of the following:
the user equipment's longitude-latitude information and elevation information on the ground;
the user equipment's wave position information.

19. The method according to claim 16, wherein the service beam resource request message implicitly indicates the location information of the user equipment;
the way in which the service beam resource request message implicitly indicates the location information of the user equipment comprises one of the following:
the detection sequence corresponds to a wave position where the user equipment is located;
a set of detection sequences corresponds to the wave position where the user equipment is located;
the detection sequence and a random access channel occasion (RO) time-frequency resource correspond to a wave position where the user equipment is located.

20. The method according to claim 18, wherein the location information of the user equipment comprises: the wave position information of the user equipment;
prior to the receiving the service beam resource request message sent by the user equipment in the control beam of the hopping beam, the method further comprises:
establishing a correspondence between the wave position information and the detection sequence;
sending the correspondence to the user equipment.

21. The method according to claim 15, further comprising:
sending a downlink broadcast signal in the control beam, wherein the downlink broadcast signal comprises the wave position number of the control beam;
the resource configuration information comprises:
a resource request response message;
service beam scheduling information;
wherein the service beam scheduling information comprises: an access time, a frequency band configuration and a residence time of the service beam.

22-23. (canceled)

24. The method according to claim 15, wherein subsequent to the sending the resource configuration information to the user equipment in the control beam, the method further comprises:
performing the random access process initiated by the user equipment in the service beam of the hopping beam.

25. The method according to claim 24, wherein performing the random access process initiated by user equipment in the service beam of the hopping beam comprises:
receiving a first message sent by the user equipment in the service beam, wherein the first message comprises a physical random access channel (PRACH) signal;
according to the first message, sending random access response (RAR) information to the user equipment in the service beam;
receiving a second message sent by the user equipment in the service beam, wherein the second message comprises: a user equipment identity and a radio resource control (RRC) connection request; and
sending random access success feedback information to the user equipment in the service beam;
wherein when the service beam resource request message does not include wave position information of the user equipment, the RAR information comprises the wave position information of the user equipment;
or
the performing the random access process initiated by user equipment in the service beam of the hopping beam comprises:
receiving a third message sent by the user equipment in the service beam, wherein the third message comprises a PRACH signal, a user equipment identity and an RRC connection request;
sending random access success feedback information to the user equipment in the service beam.

26-27. (canceled)

28. A user equipment, comprising: a storage, a transceiver and a processor, wherein
the storage is configured to store computer programs; the transceiver is configured to send and receive data under a control of the processor and perform:
sending to a network-side equipment, a service beam resource request message required for a random access, in a control beam of a hopping beam;
receiving in the control beam, resource configuration information sent by the network-side equipment; and
the processor is configured to read the computer program in the storage to perform:
initiating a random access process in a service beam of the hopping beam according to the resource configuration information.

29-41. (canceled)

42. A network-side equipment, comprising: a storage, a transceiver and a processor, wherein
the storage is configured to store computer programs; the transceiver is configured to send and receive data under a control of the processor and perform the random access method according to claim 15.

43-82. (canceled)
